(19) United States
(12) Patent Application Publication
(10) Pub. No.: US 2003/0218271 A1
(43) Pub. Date: Nov. 27, 2003

(54) Method of molding negative thermal expansion ceramics

(75) Inventors: Yuhkoh Morito, Kanagawa (JP); Kouji Takahashi, Tochigi (JP); Takuya Hashimoto, Tokyo (JP)

Correspondence Address: GREENBLUM & BERNSTEIN, P.L.C., 1950 ROLAND CLARKE PLACE, RESTON, VA, 20191, US

(73) Assignee: Moritex Corporation, Tokyo (JP)

(21) Appl. No.: 10/442,971

(22) Filed: May 22, 2003

(30) Foreign Application Priority Data
May 23, 2002 (JP) 2002-149550

(51) Int. Cl. B29C 71/00; C04B 35/653

(52) U.S. Cl. 264/235; 264/332

(57) ABSTRACT

Zr₍₁₋ₓ₎XₓW₂O₈ in which x represents a substituent element for zirconium Zr, and 0≦x<<1, having negative thermal expansion coefficient synthesized previously is heated and melted, or a starting material formed by mixing 2 mols of tungsten trioxide WO₃ and 1 mol of the sum of zirconium oxide ZrO₂ and a substituent element X in accordance with a substitution amount x at a stoichiometrical ratio and then quenching the same by being placed in a casting mold of an arbitrary shape and annealing the obtained castings by being heated at 120 to 500° C., whereby negative-thermal-expansion ceramics can be molded to arbitrary size and shape without press molding the starting powder and with no formation of voids and crackings in the inside.

### BACKGROUND OF THE INVENTION

1. Field of the Invention

The present invention concerns a method of molding negative-thermal-expansion ceramics having a negative thermal expansion coefficient, which is particularly suitable to synthesis of high density negative-thermal-expansion ceramics.

2. Statement of Related Art

Negative thermal expansion ceramics having negative thermal expansion coefficients such as ZrW₂O₈ have been expected in recent years for their application uses as materials capable of offsetting the effects of change of the shape due to temperature change of components and the like which involve the problem of control for thermal expansion.

For the method of synthesizing such negative-thermal-expansion ceramics, a solution method or a solid phase reaction method has been known.

According to the solution method (refer to U.S. Pat. Nos. 5,322,559, 5,433,778, 5,514,360, 5,919,720 and 6,183,716), single phase polycrystalline bodies of negative thermal expansion oxide ZrW₂O₈ can be synthesized by the following procedures (1) to (7).

(1): Preparation of an aqueous solution A comprising ZrOCl₂.8H₂O containing 0.5 mol of Zr and an aqueous solution B comprising (NH₄)₆H₂W₁₂O₄₀ containing 1 mol of W.

(2) Addition of the aqueous solutions A and B by 50 ml under stirring while dropping little by little to 25 ml of water.

(3): Continuous stirring of formed white precipitates for 10 hours

(4): Addition of 125 mol of 6 mol HCl, followed by reflux for 48 hours.

(5): Cooling to a room temperature, followed by decantation and filtration.

(6): Leaving resultant solids for 7 days.

(7): Heat treatment in air at 600° C.

Further, according to the solid phase reaction method, single phase polycrystalline bodies of negative-thermal-expansion ceramics ZrW₂O₈ can be synthesized by the following procedures (1) to (5).

(1): mixing powder of ZrO₂ and WO₃ at a determined compositional ratio,

(2): vacuum sealing in a silica tube,

(3): heat treatment at 1150° C. for 12 hours,

(4): pulverizing of the resultant white powder,

(5): heat treatment in a platinum crucible at 1200° C. for 12 hours.

By the way, when the negative-thermal-expansion ceramics are applied for thermal expansion controlling components, it is necessary to synthesize them in a great amount at a reduced cost.

However, in the solution method described above, since the starting materials ZrOCl₂.8H₂O and (NH₄)₆H₂W₁₂O₄₀ are poor in the stability in air, they are difficult to be used, a long time is required for the pretreatment to the heat treatment and, further, a large-scaled apparatus is necessary, as well as a great amount of chemicals other than the starting materials are required to increase the manufacturing cost.

The solid phase reaction method requires a large-scaled facility for vacuum sealing into the silica tube and the sealing operation is troublesome.

In addition, in any of the synthesis methods described above, the negative-thermal-expansion oxides ZrW₂O₈ can be made only in a small amount of less than 1 g for once and it can not cope with the demand for mass synthesis.

In view of the above, the present applicant has already proposed a method of press molding a starting powder into pellets to eliminate voids between starting particles and then sintering them for synthesizing high density negative-thermal-expansion ceramics in a great amount and at a reduced cost (Japanese patent Laid Open No. 2002-104877).

In a case of synthesizing the negative-thermal-expansion ceramics ZrW₂O₈ by the proposed method, zirconium oxide ZrO₂ and tungsten trioxide WO₃ are at first pulverized in an alumina mortar or the like and mixing them at a stoichiometrical molar ratio of 1:2.

Then, after press molding the starting powder into pellets under a pressure of 1500 to 2500 kg/cm², they are enveloped in an platinum foil and then sintered by applying a heat treatment while being kept at 1200° C. for 72 hours in atmospheric air.

According to this method, negative-thermal-expansion ceramics ZrW₂O₈ of high practical usefulness increased to a high density of about 76% of the theoretical density can be synthesized in a great amount and at a reduced cost.

However, since the starting powder has to be press-molded, the shape is restricted and, accordingly, the size of one sintered body is of about 20 mm diameter and 2 to 3 mm thickness at the greatest although it is said that this can be synthesized in a relatively great amount. If the size is made further larger, since voids are left between each of the starting particles, voids are formed also in the sintered negative-thermal-expansion ceramics to make them extremely fragile.

In view of the above, the present invention has a technical subject of enabling molding of negative-thermal-expansion ceramics of arbitrary size and shape and without press-molding the starting powders and with no voids or crackings being formed therein.

The foregoing subject can be attained in accordance with the present invention by a method of molding negative-thermal-expansion ceramics Zr₍₁₋ₓ₎XₓW₂O₈ having negative thermal expansion coefficient in which X represents a substituent element for zirconium Zr and 0≦x<<1, the method comprising heating and melting previously synthesized Zr₍₁₋ₓ₎XₓW₂O₈, then quenching the same being placed in a casting mold of an arbitrary shape and annealing the obtained castings by heating at 120 to 500° C.

The method of the invention described above is suitable to the improvement and increase of the density of negative-thermal-expansion ceramics Zr₍₁₋ₓ₎YₓW₂O₈ (0≦x<<1) synthesized previously by using, for example, yttrium Y as a substituent element for zirconium Zr in a case where voids or crackings are present therein, and negative thermal expansion high density ceramics of a dense structure with less voids can be obtained by heating to melt Zr₍₁₋ₓ₎YₓW₂O₈ at an appropriate temperature (1300° C.) that is higher than the melting point (1250° C.), casting them into a vessel formed of stainless steel or platinum and quenching them at a room temperature.

According to the study of the present inventors, the high density ceramics as quenched show no negative thermal expansion, and this may be attributable to that compressive stresses are confined in the ceramics by quenching from 1300° C.

Then, when high density ceramics as prepared were heated gradually from the room temperature to 500° C., an abrupt thermal expansion was observed at 120 to 160° C. Since the thermal expansion is irreversible, it is considered that internal strains caused by confined compressive stresses are released.

Then, after the internal stresses are released by the annealing treatment, reversible negative thermal expansion was observed within a temperature range from room temperature to a temperature of several hundreds ° C.

When the crystal structure and the composition of the negative-thermal-expansion ceramics were analyzed by scanning electron microscopy and x-ray diffractiometry, it has been found that the ceramics comprise a composite body of Zr₍₁₋ₓ₎YₓW₂O₈ with a particle size of 5 to 50 μm and zirconium oxide ZrO₂, yttrium oxide Y₂O₃ and tungsten trioxide WO₃ with a particle size of 5 μm or less formed by decomposition of Zr₍₁₋ₓ₎YₓW₂O₈ upon cooling.

It is considered that yttrium Y contributed to the densification of the tissue. However, since the deposition amount increases and the negative thermal expansion is lowered when the content exceeds 0.02, it is preferably 0.02 or less.

Further, as in a preferred embodiment to be described later, when negative-thermal-expansion ceramics ZrW₂O₈ in which zirconium Zr is not substituted with yttrium Y are melted and then applied with annealing, non-negative thermal expansion high density ceramics of dense structure with less voids can be obtained by annealing.

Then, when such a non-negative thermal expansion high density ceramics is annealed by heating to a temperature at 120° C. or higher, internal strains are released and reversible negative thermal expansion is observed in a temperature range from a room temperature to a temperature of several hundreds ° c.

When the negative-thermal-expansion ceramics ZrW₂O₈ were analyzed by scanning secondary electron microscopy and X-ray diffractiometry, it has been found that they comprise a composite body of ZrW₂O₈ with the particle size of 5 to 50 μm and zirconium oxide ZrO₂ and tungsten trioxide WO₃ with the particle size of 5 μm or less formed by decomposition of ZrW₂O₈ upon cooling.

Then, the present invention provides in another feature a method of molding negative-thermal-expansion ceramics Zr₍₁₋ₓ₎XₓW₂O₈ having negative thermal expansion coefficient in which X represents a substituent element for zirconium Zr, and 0≦x<<1, the method comprising mixing two mols of tungsten trioxide WO₃ and one mol of the sum of zirconium oxide ZrO₂ and a substituent element X in accordance with the substitution amount x at a stoichiometrical ratio, heating and melting the mixed starting material, then quenching the same being placed in a casting mold of an arbitrary shape, and then annealing the obtained castings by heating at a temperature from 120 to 500° C.

In the method of synthesizing the negative-thermal-expansion ceramics Zr₍₁₋ₓ₎XₓW₂O₃ (0≦x<<1) having a negative thermal expansion coefficient with no voids or crackings according to the above-mentioned feature of the present invention, non-negative thermal expansion high density ceramics of a dense structure with less voids can be obtained also by mixing zirconium oxide ZrO₂, yttrium oxide Y₂O₃ in accordance with the substitution amount of x and tungsten trioxide (WO₃), in a case of using yttrium (Y), for example, as a substituent element for zirconium Zr, heating and melting the thus obtained starting material at an appropriate temperature (1300° C.) that is higher than the melting point of Zr₍₁₋ₓ₎XₓW₂O₈ (1250° C.), and quenching the same by casting into a vessel formed of stainless steel or platinum at a room temperature.

Then, when such a non-negative thermal expansion high density ceramics is annealed by heating to a temperature at 120° C. or higher, internal strains are released and reversible negative thermal expansion is observed in a temperature range from a room temperature to a temperature of several hundreds ° C.

ZrW₂O₈ having a negative thermal expansion coefficient can be obtained also by heating and melting the starting material formed by mixing zirconium oxide ZrO₂ and tungsten trioxide WO₃ at a stoichiometrical ratio of 1:2, quenching the same being placed in a casting mold of an arbitrary shape and then annealing the resultant castings by heating at 120 to 500° C.

### DESCRIPTION OF THE ACCOMPANYING DRAWINGS

FIG. 1 is an explanatory view showing the method of the present invention;

FIG. 2 is a graph showing the thermal deformation behavior in an annealing treatment;

FIG. 3 is a graph showing the thermal deformation behavior of negative-thermal-expansion ceramics according to the present invention; and

FIG. 4 is an explanatory view showing another embodiment of the present invention.

### PREFERRED EMBODIMENTS OF THE INVENTION

The present invention is to be described specifically by way of preferred embodiments with reference to the drawings.

Since negative-thermal-expansion ceramics such as Zr₍₁₋ₓ₎YₓW₂O₈ (0≦x<<1) comprising sintered body in which zirconium Zr is substituted with yttrium Y contain a lot of voids, description is to be made to a case of modifying them.

Molding was conducted by the method according to the present invention for each of negative-thermal-expansion ceramics Zr₍₁₋ₓ₎YₓW₂O₈ (0≦x<<1) synthesized previously at a mixing ratio of Zr:Y:W of: (1) 1:0:2, (2) 0.995:0.005:2, (3) 0.99:0.01:2, (4) 0.985:0.015:2, and (5) 0.98:0.02:2, corresponding to the substitution amount; x=0, 0.005, 0.01, 0.015 and 0.02.

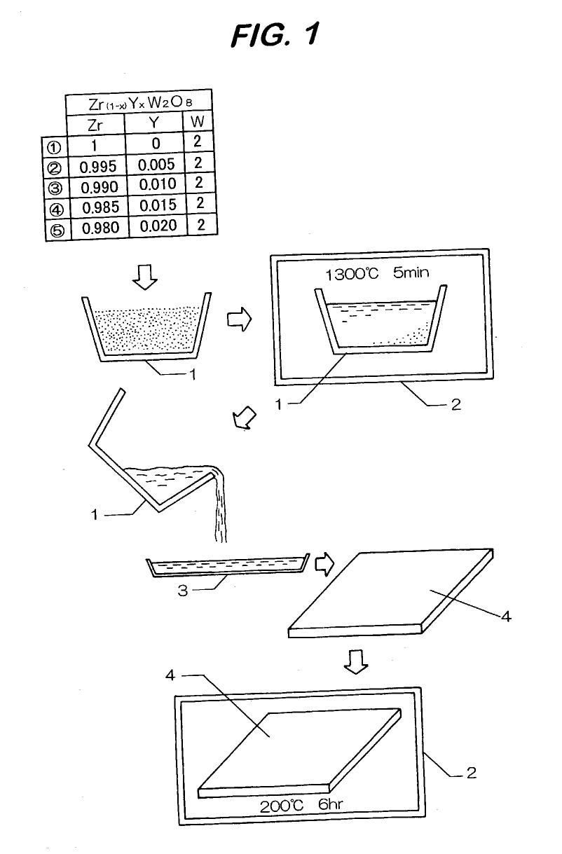

In the method of molding negative-thermal-expansion ceramics shown in FIG. 1, a platinum crucible 1 containing previously synthesized Zr₍₁₋ₓ₎YₓW₂O₈ was set in an electric furnace 2 at a room temperature, the temperature of the electric furnace 2 was elevated to 1300° C. for 1 hour and kept for 5 min, and then the molten liquid in the platinum crucible 1 was poured into a bat-shaped casting mold 3 made of stainless steel and quenched. Plate-like samples 4 each of 60 mm length×60 mm width×3 mm thickness with scarce voids could be molded.

The obtained samples 4 were again placed in the electric furnace 2 at a room temperature and then applied with annealing treatment by being heated at 200° C. for 6 hours.

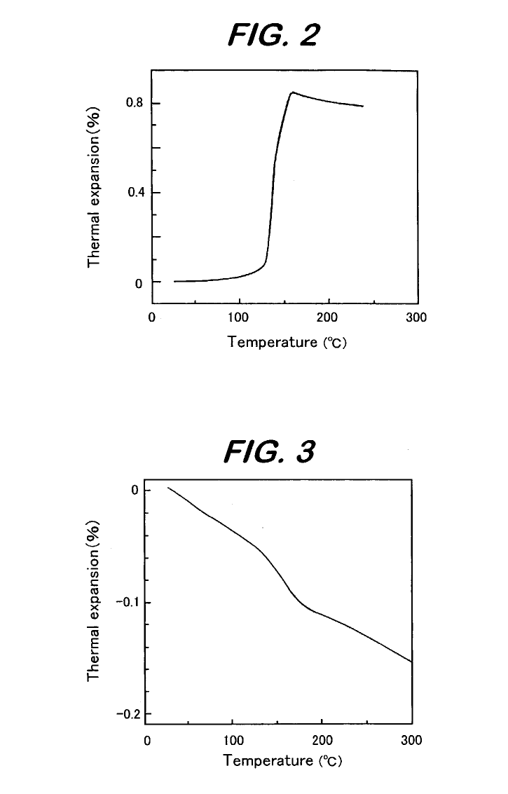

FIG. 2 is a graph showing the deformation behavior of the sample 4 along with the temperature change in the annealing.

According to the graph, each sample shows an abrupt thermal expansion at a temperature from 120° C. to 160° C. and, since the thermal expansion is not reproduced, this is considered that internal strains caused by the compressive stresses applied to the sample 4 were released.

The annealing temperature may be 120° C. or higher and, since the processing time can be shortened as the temperature is higher, it is preferably 160° C. or higher and, more preferably, 200° C. or higher.

When the crystal structure and the composition of each sample 4 obtained as described above were observed by scanning secondary electron microscopy and X-ray diffractiometry, voids were not observed in each sample, different from the sintered body and the sample was comprised of a composite body of Zr₍₁₋ₓ₎YₓW₂O₈ with the particle size of 5 to 50 μm and zirconium oxide ZrO₂ and tungsten trioxide WO₃ with the particle size of 5 μm or less formed by decomposition of Zr₍₁₋ₓ₎YₓW₂O₈ upon cooling and was hard and tough in view of the mechanical strength compared with the sintered body.

Then, for each sample 4 completed with the annealing treatment, temperature elevation and lowering were repeated between the room temperature and 300° C.

FIG. 3 is a graph showing the deformation behavior of each sample 4 along with the temperature change. According to the experiment, the sample 4 had negative thermal expansion coefficient and ZrW₂O₈, for example, shows a negative thermal expansion of about 0.15% when heated from the room temperature to 300° C., and −5.2×10⁻⁶ (K⁻¹) in average between room temperature and 100° C. and −4.5×10⁻⁶ (K⁻¹) in average between 200 to 300° C.

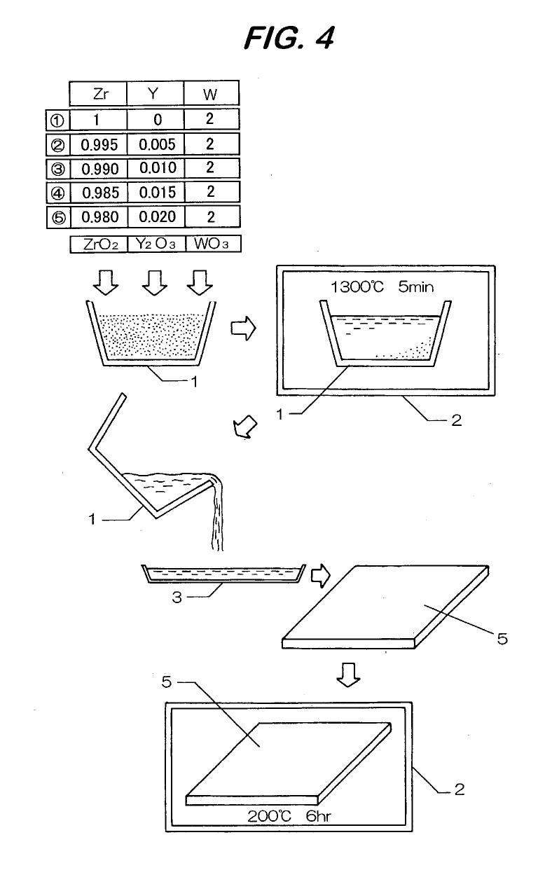

FIG. 4 shows synthesis of negative-thermal-expansion ceramics Zr₍₁₋ₓ₎YₓW₂O₈ (0≦x<<1) having a negative thermal expansion coefficient. A starting material formed by mixing 2 mol of tungsten trioxide WO₃ and 1 mol of the sum of zirconium oxide ZrO₂ and yttrium oxide (Y₂O₃) in accordance with substitution amount x at a stoichiometrical ratio.

Also in this example, ingredients were mixed such that the mixing ratio of Zr:W:Y was (1) 1:0:2, (2) 0.995:0.005:2, (3) 0.99:0.01:2, (4) 0.985:0.015:2, and (5) 0.98:0.02:2, such that five types of Zr₍₁₋ₓ₎YₓW₂O₈ could be molded corresponding to the substitution amount of yttrium for zirconium Zr; x=0, 0.005, 0.01, 0.015, and 0.02.

A platinum crucible 1 containing the starting material was set to an electric furnace 2 at a room temperature, the temperature of the electric furnace 2 was elevated to 1300° C. for 1 hour and kept for 5 min, and then the molten liquid in the platinum crucible 1 was poured into a bat-shaped casting mold 3 made of stainless steel and quenched. Plate-like samples each 5 of 60 mm length×60 mm width×3 mm thickness with scarce voids could be molded.

Each obtained sample 5 was again placed in the electric furnace 2 at a room temperature and then applied with an annealing treatment by being heated at 200° C. for 6 hours.

Also in this case, each sample showed abrupt thermal expansion at a temperature from 120° C. to 160° C. like the deformation behavior shown in FIG. 2, and each sample 5 after completion of the annealing was tough negative-thermal-expansion ceramics having negative thermal expansion coefficient.

When the crystal structure and the composition of each sample 4 obtained as described above were observed by scanning secondary electron microscopy and x-ray diffractiometry, voids were not observed in each sample different from the sintered body and the sample was composed of a composite body of Zr₍₁₋ₓ₎YₓW₂O₈ with the particle size of 5 to 50 μm and zirconium oxide ZrO₂ and tungsten trioxide WO₃ with the particle size of 5 μm or less formed by decomposition of Zr₍₁₋ₓ₎YₓW₂O₈ upon cooling, and hard and tough in view of the mechanical strength compared with the sintered body.

That is, Zr₍₁₋ₓ₎YₓW₂O₈ in a molten state was obtained by melting tungsten trioxide WO₃, zirconium oxide ZrO₂, and yttrium oxide Y₂O₃ as the starting material, and the sintered body described above was molded by quenching the same and then applying annealing.

In the foregoings, description has been made to a case of substituting zirconium Zr with yttrium Y, but the present invention is not restricted thereto and is also applicable to a case of molding negative-thermal-expansion ceramics, for instance, Zr₍₁₋ₓ₎ScₓW₂O₈ or Zr₍₁₋ₓ₎InₓW₂O₈ using scandium Sc or indium In capable of substituting for zirconium Zr.

As has been described above, since the present invention can mold negative-thermal-expansion ceramics by a casting method, it can provide an excellent effect capable of molding tough negative-thermal-expansion ceramics into an arbitrary size and arbitrary shape with scarce formation of voids and crackings in the inside as in the existent sintered body.

The present disclosure relates to subject matter contained in priority Japanese Patent Application No. 2002-149,550 filed on May 23, 2002, the contents of which is herein expressly incorporated by reference in its entirety.

What is claimed is:

1. A method of molding negative-thermal-expansion ceramics Zr₍₁₋ₓ₎XₓW₂O₈ having negative thermal expansion coefficient in which X represents a substituent element for zirconium Zr, and 0≦x<<1, the method comprising heating and melting previously synthesized Zr₍₁₋ₓ₎XₓW₂O₈, then quenching the same being placed in a casting mold of an arbitrary shape and annealing the obtained castings by heating at 120 to 500° C.

2. A method of molding negative-thermal-expansion ceramics Zr₍₁₋ₓ₎XₓW₂O₈ having negative thermal expansion coefficient in which X represents a substituent element for zirconium Zr, and 0≦x<<1, the method comprising mixing two mols of tungsten trioxide WO₃ and one mol of the sum of zirconium oxide ZrO₂ and a substituent element X in accordance with substitution amount x at a stoichiometrical ratio, heating and melting the mixed starting material, then quenching the same being placed in a casting mold of an arbitrary shape, and then annealing the obtained castings by heating at a temperature from 120 to 500° C.

3. A method of molding negative-thermal-expansion ceramics according to claim 1 or 2, wherein the substitution amount x of the substituent element X for zirconia Zr is 0 and the negative-thermal-expansion ceramics are ZrW₂O₈.

4. A method of molding negative-thermal-expansion ceramics according to any one of claims 1 to 3, wherein the annealing temperatures is from 160 to 500° C., more preferably, 200 to 500° C.

5. A method of molding negative-thermal-expansion ceramics according to any one of claims 1 to 4, wherein the substituent element X is yttrium Y, scandium Sc or indium In.

6. A method of molding negative-thermal-expansion ceramics comprising quenching Zr₍₁₋ₓ₎XₓW₂O₈ in which X represents a substituent element for zirconium Zr, and 0≦x<<1, in a molten state, and then annealing the same at 120 to 500° C., thereby molding Zr₍₁₋ₓ₎XₓW₂O₈ comprising a composite body of Zr₍₁₋ₓ₎XₓW₂O₈ in which x represents a substituent element for zirconium Zr, and 0≦x<<1, with a particle size of 5 to 50 μm, and zirconium oxide ZrO₂, tungsten trioxide WO₃ and oxide XOₙ of the substituent element X with a particle size of 5 μm or less formed by decomposition of Zr₍₁₋ₓ₎XₓW₂O₈.
